(19) United States
(12) Patent Application Publication
(10) Pub. No.: US 2006/0155431 A1
(43) Pub. Date: Jul. 13, 2006

(54) Vehicle information system with remote communicator

(76) Inventors: Frederick J. Berg, Auburn, MI (US); Remon S. Jiddou, Oak Park, MI (US); Ronald H. Dybalski, Oxford, MI (US); Jason L. Grunder, Midland, MI (US); Timothy J. Bennett, Kawkawlin, MI (US); Richard K. Riefe, Saginaw, MI (US)

Correspondence Address: DELPHI TECHNOLOGIES, INC., M/C 480-410-202, PO BOX 5052, TROY, MI, 48007, US

(21) Appl. No.: 11/370,370

(22) Filed: Mar. 8, 2006

Related U.S. Application Data
(63) Continuation-in-part of application No. 10/793,193, filed on Mar. 4, 2004.
(60) Provisional application No. 60/660,492, filed on Mar. 10, 2005.

(51) Int. Cl. G05D 1/00

(52) U.S. Cl. 701/2; 701/100

(57) ABSTRACT

An information system for a vehicle includes a computer for handling informational data. This information data includes vehicle data corresponding to operation of the vehicle and external data such as internet web pages and email. A primary display is connected to the computer and in a position to be viewed by a driver of the vehicle. A primary input device allows input to the computer and manipulation of the primary display. A remote communicator is also operatively connected to the computer and movable about the vehicle. The remote communicator includes a secondary display and a secondary input device for sending input to the computer and manipulating the secondary display. The secondary input device is also programmed to control the primary display for manipulating the informational data that is displayed to the driver. The remote communicator may be a programmable handheld computer or PDA interfacing with the vehicle computer through an internal wireless network.

### CROSS-REFERENCE TO RELATED APPLICATIONS

This application is a continuation-in-part of U.S. Ser. No. 10/793,193 filed Mar. 4, 2004, and also claims the benefit of priority to U.S. Provisional Application No. 60/660,492 filed Mar. 10, 2005.

### FIELD OF THE INVENTION

The subject invention relates generally to information systems for vehicles and specifically to information system for vehicles including a remote communication device.

### BACKGROUND OF THE INVENTION

Information systems for vehicles are well known in the prior art. Examples of such systems are described in U.S. Pat. No. 5,555,502 to Opel (the '502 patent) and U.S. Pat. No. 6,427,115 to Sekiyama (the '115 patent).

The '502 patent discloses an information system for a vehicle. The information system includes a computer connected to the various systems of the vehicle for sending and receiving information from the various systems. The computer is also connected to an input device for receiving inputs from a driver of the vehicle and a display that is viewable by the driver. The driver uses the input device in conjunction with the screen to review vehicle information and adjust any adjustable settings.

The '115 patent discloses an information system for a vehicle with a remote communicator. A computer receives vehicle data relating to the vehicle operation and external data such as navigational information, email, etc. The computer is operatively connected to the remote communicator to send and receive information from the remote communicator. The remote communicator includes a display and allows a driver or an occupant to determine directions to a destination, read email, etc.

Although the information systems of the prior art are useful in disseminating information to the driver and occupants of the vehicle, there remains an opportunity to provide an information system which allows greater interaction and exchange of information between the driver and the occupant.

### SUMMARY OF THE INVENTION AND ADVANTAGES

A vehicle information system comprises a computer for handling informational data. This informational data includes vehicle data corresponding to operation of the vehicle and associated vehicle systems. A remote communicator is operatively connected to the computer and moveable about the vehicle. The remote communicator includes a secondary display for changeably displaying the informational data to an occupant of the vehicle. The remote communicator also includes a secondary input device for sending commands to the computer and controlling the secondary display. Both the secondary display and the secondary input device include a shared reconfigurable touch screen interface.

According to another aspect of the invention, a method for controlling at least one vehicle system through a hand-held wireless device comprises the steps of providing a remote communicator having a touch screen interface, linking the remote communicator to an on-board vehicular computer through an internal wireless interface, triggering a vehicle system control setting session via the computer by contact pressure with the touch screen interface, displaying a plurality of vehicle control function choices on the touch screen interface, selecting a vehicle control function by contact pressure with the touch screen interface, requesting a change in a vehicle control setting by contact pressure with the touch screen interface, receiving the change request in the vehicular computer, and initiating the change request.

Accordingly, the subject invention allows an occupant of the vehicle to view information using the remote communicator and send information to the vehicle computer through the shared touch screen interface. This allows any occupant in or near the vehicle, including non-driving occupants, to handle tasks such as finding directions, changing the radio station, etc.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic diagram of an information system for a vehicle;

FIG. 2 is a perspective view of a driver's position in the vehicle including a primary display and a primary input device;

FIG. 3 is a perspective view of the primary input device implemented as a primary switch;

FIG. 4 is a view of a main menu displayed on the primary display;

FIG. 5 is a view of a sub-menu displayed on the primary display;

FIG. 6 is a perspective view of a remote communicator including a secondary display and a secondary input device;

FIG. 7 is a perspective view of a dashboard of the vehicle including a storage compartment for the remote communicator;

FIG. 8 is a perspective view of the dashboard of the vehicle including the remote communicator in a position such that the secondary display may be viewed;

FIG. 9 is a perspective view showing the remote communicator connected via a cable;

FIG. 10 is a perspective view showing the remote communicator connected via an internal wireless interface;

FIG. 11 is a schematic view depicting an exemplary whole plan view together with block diagrams to represent the remote communicator vehicle interface;

FIG. 12 is a flow chart depicting a preferred method for controlling at least one vehicle system through a hand-held wireless device;

FIG. 13 is a perspective view as in FIG. 10 and depicting the remote communicator in the form of a personal digital assistant (PDA);

FIG. 14 is an enlarged view of the preferred remote communicator according to the subject invention;

FIG. 15 is an exemplary view of the touch screen interface for the remote communicator displaying a menu for the Navigation and Communication primary category;

FIG. 16 is an exemplary view of the touch screen interface for the remote communicator displaying a menu for the Entertainment primary category;

FIG. 17 is an exemplary view of the touch screen interface for the remote communicator displaying a menu for the Vehicle Information primary category; and

FIG. 18 is an exemplary view of the touch screen interface for the remote communicator displaying a menu for the Comfort primary category.

### DETAILED DESCRIPTION OF THE PREFERRED EMBODIMENT

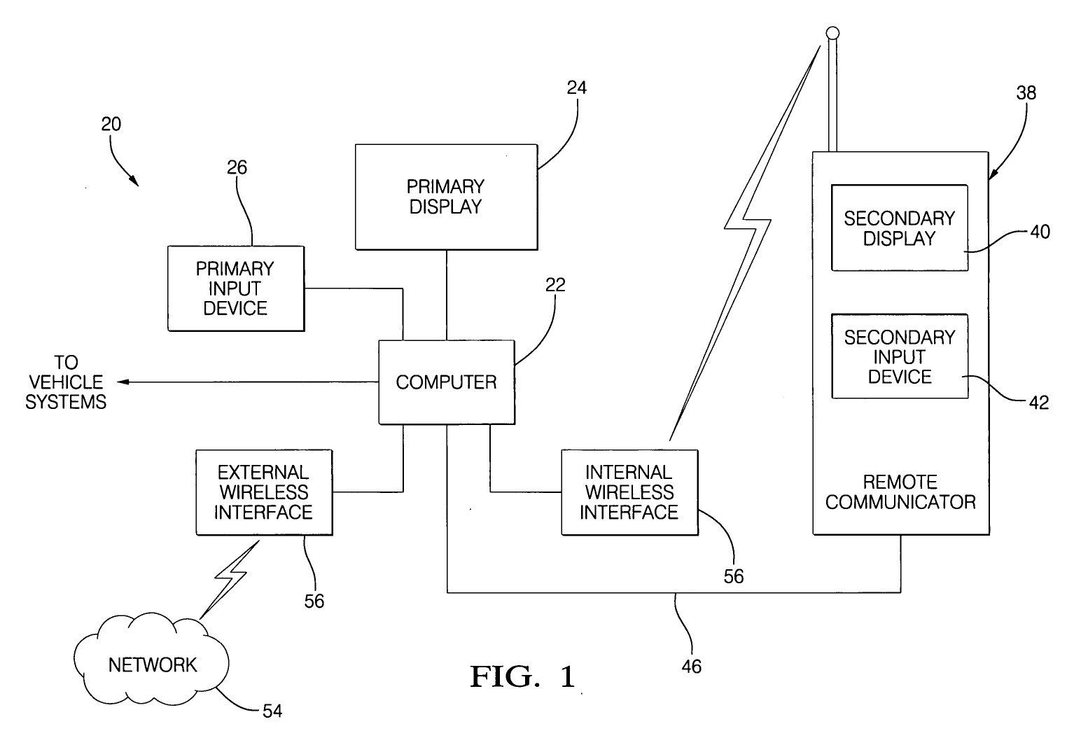

Referring to the Figures, wherein like numerals indicate like parts throughout the several views, an information system for a vehicle is shown at 20 in FIG. 1.

The system 20 includes a computer 22 for handling informational data, including vehicle data. The computer 22 preferably includes a main microprocessor to manage the receiving, storing, sending, calculating, and manipulating of the informational data. The computer 22 also includes other necessary electronic components known to those skilled in the art, such as a memory, a hard drive, communication interfaces, a power supply/converter, digital and analog converters, etc.

The computer 22 is connected to vehicle systems that provide the vehicle data which corresponds to the operation of the vehicle and associated vehicle systems. Examples of these vehicle systems include, but are not limited to, an engine controller, a climate control system, an integrated cellular phone system, a sound system (radio), a global positioning system (GPS) receiver, and a video entertainment center (such as a DVD player). Examples of vehicle data provided by the vehicle systems include, but are not limited to vehicle speed, engine RPMs, engine oil pressure, engine coolant temperature, battery voltage, vehicle maintenance reminders, climate control system settings, outside temperature, radio settings, integrated cellular phone settings, compass headings, video images, sound files, digital radio broadcasts, and navigational information.

The informational data handled by the computer 22 also includes external data from a network 54 external to the vehicle. An external wireless interface 56 is operatively connected to the computer 22 to communicate with the network 54 for sending and receiving the external data. The external data includes, but is not limited to internet web pages, e-mail, and navigational information.

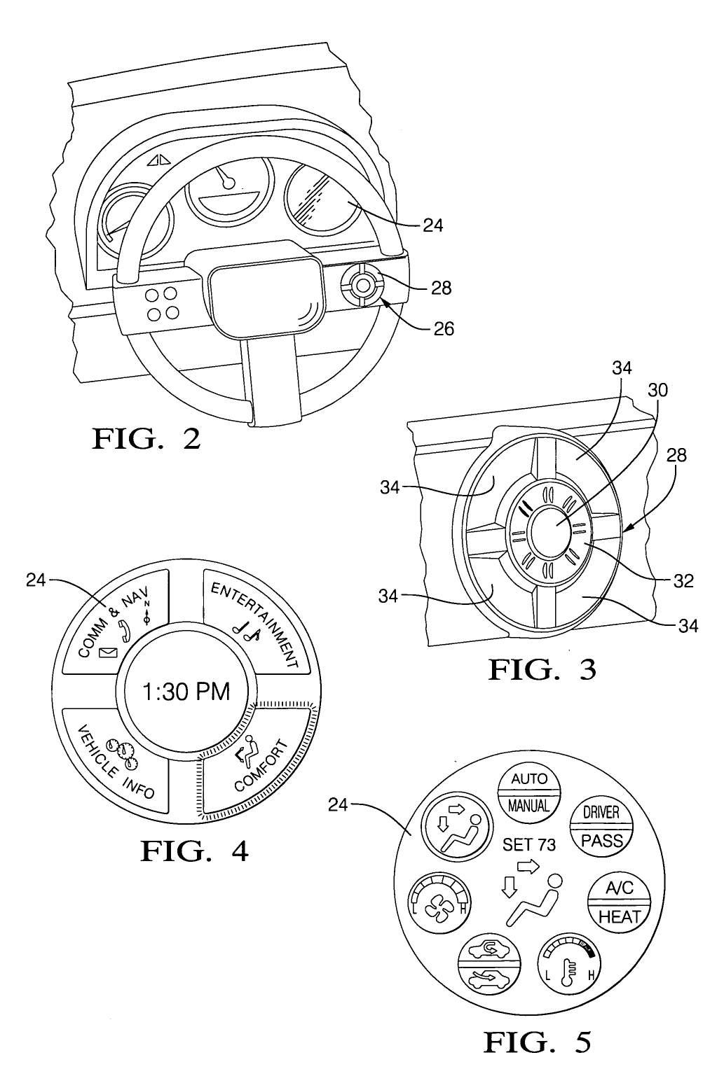

Referring now to FIG. 2, a primary display 24 is permanently affixed to the vehicle in a position to be viewed by a driver of the vehicle. Although the primary display 24 is shown in FIG. 2 as part of an instrument panel, the primary display 24 could be implemented in other locations, such as on a dashboard, a sun visor, or projected on a windshield as a “heads-up” display.

The primary display 24 is operatively connected to the computer 22 for displaying the informational data to the driver of the vehicle. A primary input device 26 is also operatively connected to the computer 22. The primary input device 26 allows the driver, or other occupant of the vehicle, to send commands to the computer 22. The driver or other occupant also uses the primary input device 26 to control the primary display 24, including changing the informational data that is displayed to the driver.

A primary switch 28 may be implemented as the primary input device 26. The primary switch may be mounted on the steering wheel, the dashboard, or other suitable locations within the vehicle. Referring now to FIG. 3, the primary switch 28 preferably includes a pushbutton 30, a rotary thumbwheel 32, and a plurality of mode switches 34. The pushbutton 30, rotary thumbwheel 32, and plurality of mode switches 34 are used in conjunction with one another to allow the driver, or other occupant, to navigate and control the primary display 24. For example, each of the plurality of mode switches 34 may correspond to a category of vehicle systems. Examples of these categories could include “Vehicle Information”, “Comfort”, “Entertainment”, and “Communication and Navigation”. These categories may appear on the primary display 24, as shown in FIG. 4. Each mode switch 34 is preferably color-coded to match colors of the categories shown on the primary display 24. When one of the mode switches, such as “Comfort”, is depressed, the primary display 24 changes to show the detailed settings for that category, as exemplified in FIG. 5. The rotary thumbwheel 32 is then used to navigate through the detailed settings. Selection of a particular detailed setting is accomplished by depressing the pushbutton 30.

Alternatively, the primary input device 26 may be implemented as a touchscreen interface (not shown). Touchscreen interfaces are well known to those skilled in the art. Typically, a transparent layer consisting of a resistive or a capacitive material is placed over a display, such as the primary display 24 of the subject invention. The driver or other occupant taps the layer, with a finger or a stylus, to select an item shown on the primary display 24. The touchscreen interface then determines the location of tapped selection and sends location coordinates to the computer 22. The computer 22 correlates the coordinates with the images shown on the primary display 24 to determine what has been selected.

Those skilled in the art appreciate that other implementations of the primary input device 26, other than the primary switch 28 and touchscreen interface described above, are possible. These other implementations include, but are not limited to, a keypad, a keyboard, and a speech recognition system.

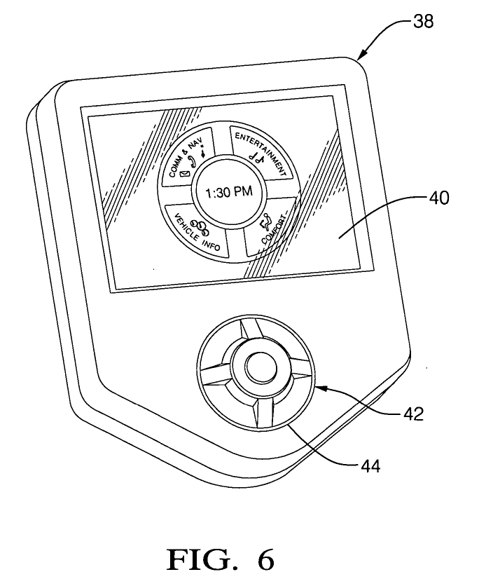

The system 20 also includes a remote communicator 38 operatively connected to the computer 22. The remote communicator 38, shown in FIG. 6, is movable about the vehicle for use by the driver or the other occupants of the vehicle. The remote communicator includes a secondary display 40 for displaying the informational data to the driver or the other occupants. The secondary display 40 can display the same informational data as is available on the primary display 24 with the same formatting.

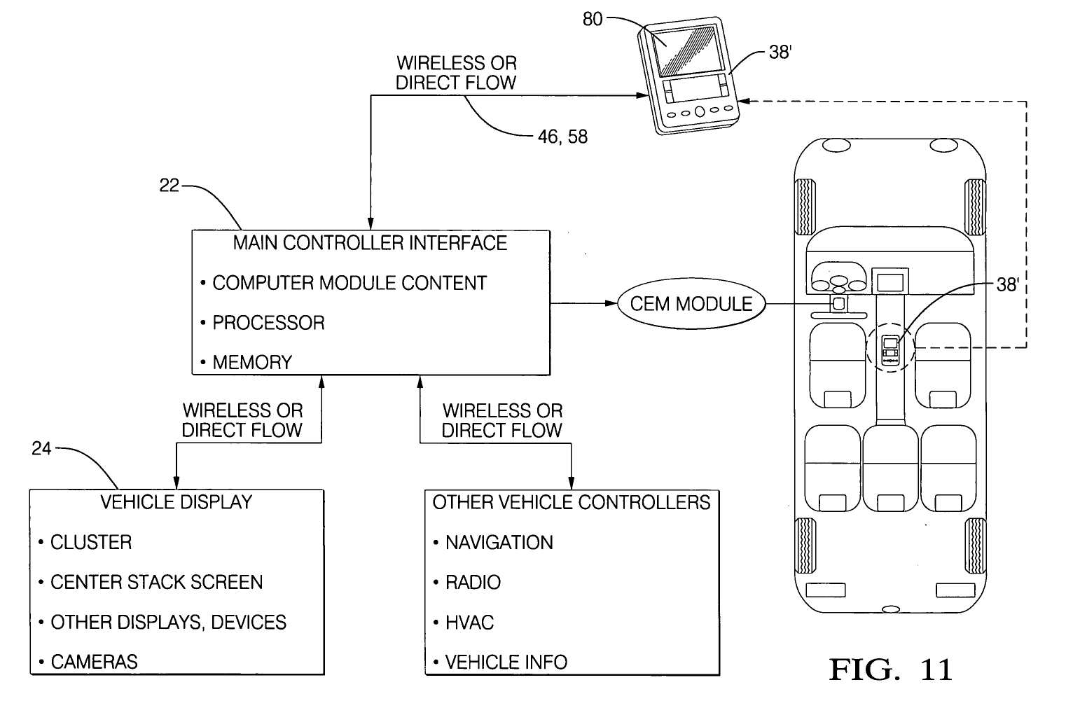

The remote communicator 38 also includes a secondary input device 42 for sending commands to the computer 22 and controlling the secondary display 40. The secondary input device 42 is analogous to the primary input device 26. It is preferred that the secondary input device 42 be implemented as a secondary switch 44. As with the primary switch 28, the secondary switch 44 preferably includes the pushbutton 20, the rotary thumbwheel 22, and the plurality of mode switches 24. Operation with the secondary switch 44 is comparable to operation of the primary switch 28 described above. Alternatively, the secondary input device 42 may be implemented as the touchscreen interface as described above, or any other suitable implementation including those depicted in FIGS. 11-18.

The secondary input device 42 of the remote communicator 38 is also programmed to allow control of the primary display 24. This allows occupants of the vehicle to manipulate the informational data that is displayed to the driver. For example, the occupant could operate the remote communicator 38 to find navigational information, such as directions to a particular destination. Once the directions are located, the occupant can transfer the directions to the primary display 24. This allows the driver of the vehicle to focus his or her concentration on the task of driving, instead of looking up directions. Alternatively, the occupant of the vehicle could use the remote communicator 38 to find several restaurants and their locations superimposed on a map. The occupant could then send this map to the primary display 24, allowing the driver to choose a restaurant and drive to its location.

The computer 22 and remote communicator 38 are programmable to prevent certain informational data from being displayed on the secondary display 40 or manipulated with the secondary input device 42. For example, the driver of the vehicle could prevent the occupant using the remote communicator 38 from changing radio stations, altering climate controls, etc.

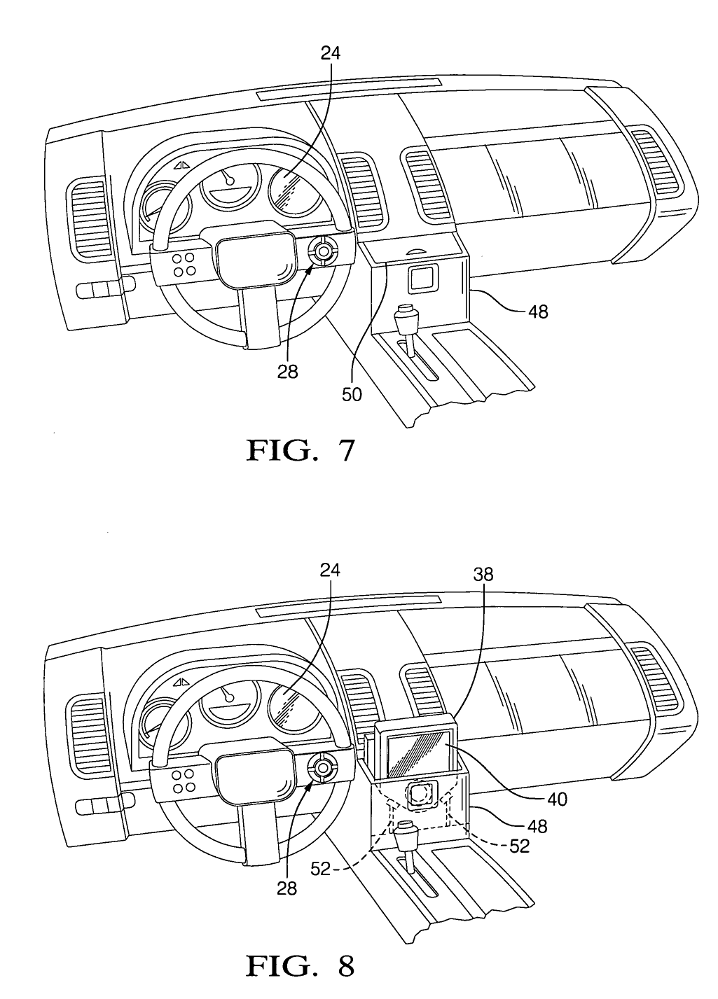

Referring to FIG. 7, the vehicle also includes a storage compartment 48 for storage of the remote communicator 38. The storage compartment is preferably located in a center console of the vehicle. The storage compartment 48 includes a first configuration for completely concealing the remote communicator 38 when not in use. The storage compartment 48 includes a lid 50 to cover and conceal the remote communicator 38 while in the first configuration. The lid may be opened manually or by an automatic mechanism (not shown).

The storage compartment 48 also includes a second configuration. In this second configuration, the remote communicator 38 is held in a position that allows viewing of the secondary display 40, as shown in FIG. 8. It is preferred that the storage compartment 48 include a lifting apparatus 52 for moving the remote communicator 38 between the first configuration and the second configuration. The lifting apparatus 52 may be manually or automatically operable.

In addition to controlling the primary display 24, the primary input device 26 is also programmed to control the secondary display 40 of the remote communicator 38. This is especially beneficial when the remote communicator 38 is housed in the storage compartment 48 in its second configuration, where the secondary display 40 is viewable. The driver of the vehicle can then use the secondary display 40 as a supplement to the primary display 24. For example, the driver could set the primary display 24 to show climate control settings, while having the secondary display 40 show radio control information.

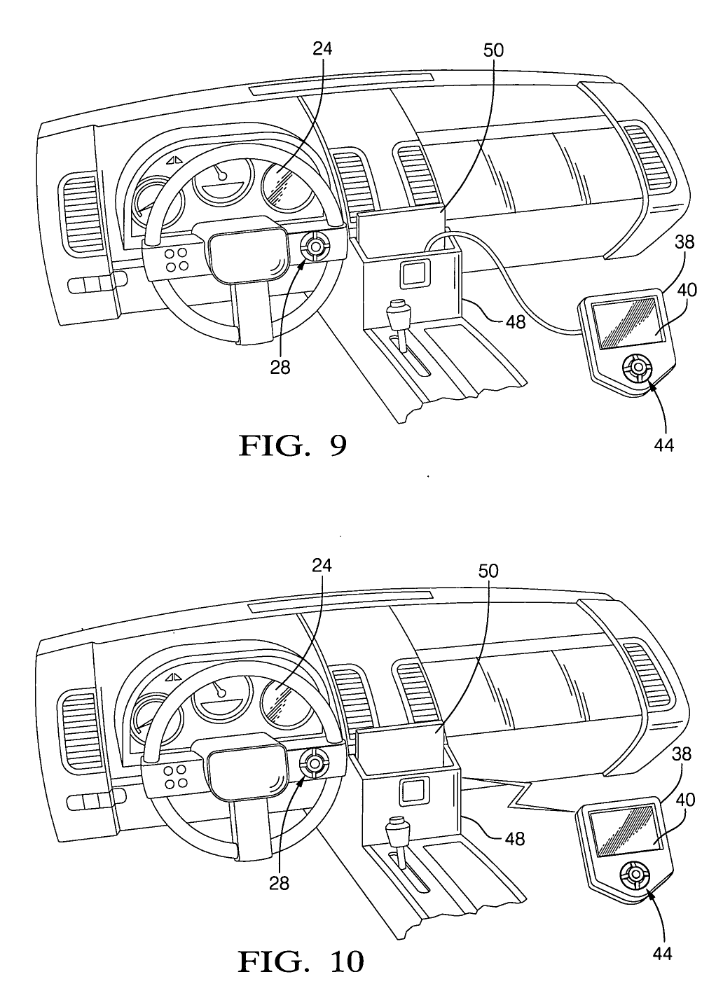

Numerous devices may be used to operatively connect the remote communicator 38 to the computer 22. One possible device, as shown in FIG. 9, is a cable 46 to physically “hardwire” the remote communicator 38 to the computer 22 for transferring the informational data. Those skilled in the art realize the cable 46 may carry the informational data via electrical or optical signals. A second possible device is preferred to operatively connect the remote communication 38 and the computer 22. The second possible device is an internal wireless interface. The internal wireless interface links the remote communicator 38 to the computer without the use of a physical interface, as shown in FIG. 10. Preferably, the remote communicator 38 and the computer 22 are both outfitted with wireless transceivers (not shown). The radio transceivers communicate the informational data to one another using radio waves. Alternatively, optical transceivers can be implemented to communicate using waves in the optical spectrum. Suitable protocols include, but are not limited to, Bluetooth, 802.11, and IRDA.

Referring now to FIGS. 11-18, a particular embodiment of the remote communicator 38′, connected to the computer 22 through the internal wireless interface 58, is described in which the remote communicator takes the form of a programmable handheld device such as a personal digital assistant (PDA), a so-called pocket PC, or a handheld computer. The terms PDA, pocket PC and handheld computer are used interchangeably throughout to refer to the ubiquitous type of interactive hand held processing device typically used by a person for non-vehicular activities. For example, the PDA or handheld computer may operate also as a telephone, a calendar device, a device for connecting to the internet, an email device, or any other such application to which such devices are commonly put to use. Thus, in the case of the vehicle occupant who uses a PDA in the normal course of their daily activities for work, home, and extra curricular functions, the same PDA can be operated as the remote communicator 38′ and used in the context of the subject invention.

More specifically, and referring to FIG. 11 wherein a schematic plan view of an automobile is depicted, the subject remote communicator 38′, in the exemplary form of a PDA, is shown interfacing with the main controller which, in this example, comprises the computer 22. The computer 22 contains a processor and memory capable of receiving communications from the primary 26 and secondary 42 input devices as well as displaying vehicular information and choice selections to the primary 24 and secondary 40 displays. The computer 22 also is capable of initiating changes to the vehicle systems as may be directed by the person in control of the remote communicator 38′.

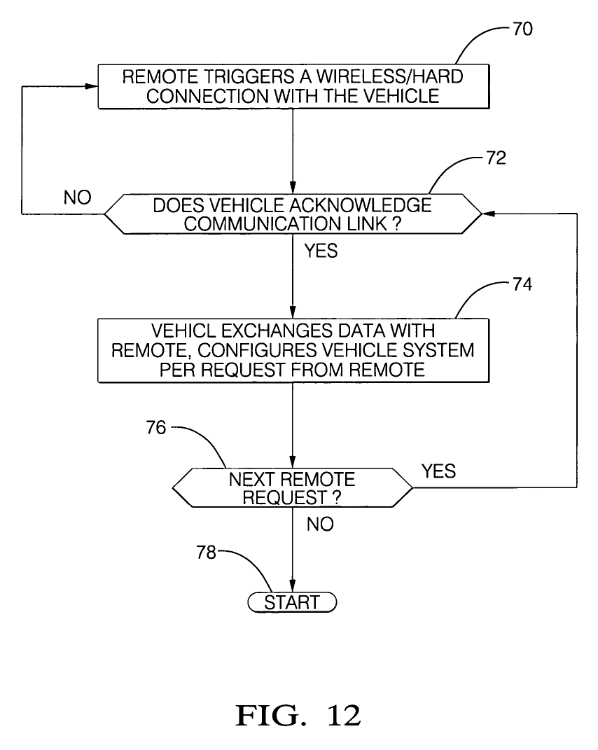

FIG. 12 depicts a typical logic program carried out between the remote communicator 38′ and the computer 22. In function block 70, the remote communicator 38′ triggers a wireless 58 or hard cable 46 connection with the on-board vehicle computer 22. The logic then flows to query 72 where it is determined whether the computer 22 has acknowledged the communication link with the remote communicator 38′. If not, the logic is looped back to function block 70. If answered in the affirmative, however, the computer 22 exchanges data with the remote communicator 38′, and configures the vehicle system accordingly as per function block 74. The computer 22 then waits, in function block 76, for the next request from the remote communicator 38′. If there is another request, then the logic returns to query 72. There are no further requests received from the remote communicator 38′ within the allotted time, the logic ends at 78.

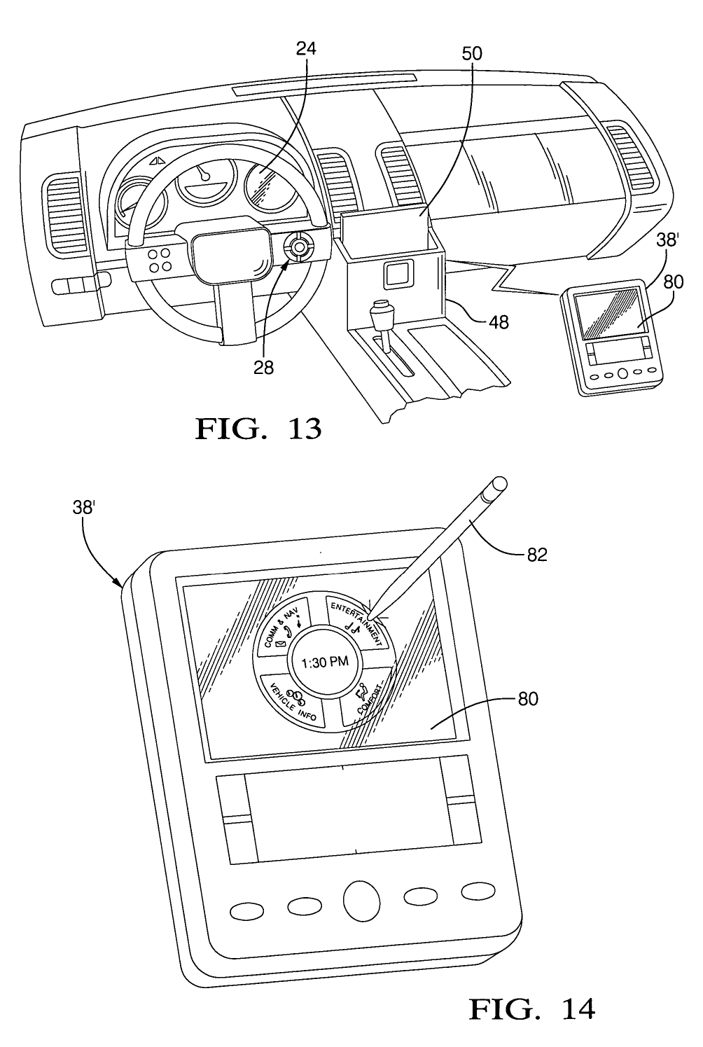

Referring now to FIGS. 13 and 14, the subject remote communicator 38′ is shown more clearly in the form of a typical personal digital assistant (PDA). It will be understood by those skilled in the art, however, that the remote communicator 38′ can take the form of a pocket PC, a handheld computer or perhaps other type of interactive mobile logic device in the possession of a person within range of the internal wireless interface 58. In the case of a PDA, both the secondary display and the secondary input device are shared in a touch screen interface 80. Thus, information is displayed and instructions are issued through the same medium. FIG. 14 displays the mode switch in a configuration similar to that depicted in FIG. 4, and may thus be considered a Simulated Primary Display. The Simulated Primary Display comprises a representative Main Menu. Using a stylus 82, any one of the categories of vehicle systems can be selected by the operator. As previously described in connection with the actual primary display 24, these categories can include “Vehicle Information”, “Comfort”, “Entertainment”, and “Communication and Navigation”. Events/Modes depicted in FIG. 14 are shown to include:

1) Comm/Nav: Open Communication Navigation Screen

2) Entertainment: Open Entertainment Screen

3) Comfort: Open Comfort Screen

4) Vehicle Info: Open Vehicle Information Screen

5) Connection; Connect: Attempt to connect to Server

6) Connection; Disconnect: Disconnect from Server

7) Connection Test Connection: ping server I/P address

8) Exit: Shutdown Remote Application

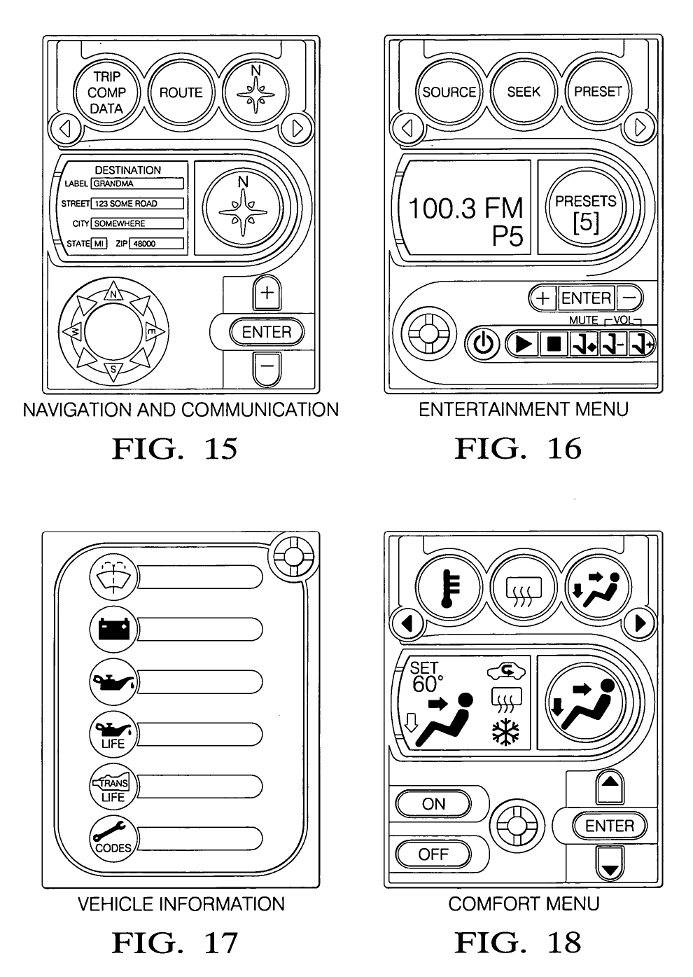

FIG. 15 represents an exemplary menu which may be displayed upon the touch screen interface 80 when the Navigation Communication category is selected by contact pressure through the stylus 82. Events/Modes depicted in FIG. 15 are shown to include:

Left Menu Scroll—scroll menu button Left

Right Menu Scroll—Scroll menu button right

Navigation Menu Btn—Open Navigation Screen

Route Menu Btn—Open Route screen

Camera Menu Btn—set main bubble/display to “camera” mode

Trip Computer Data Menu btn—set main bubble/display to “trip data” mode

Phone Menu Btn—set main/Bubble display to “phone” mode

Email menu btn—set main bubble/display to “email” mode

Reset Button—Reset selected trip data value

UP button—change mode selection

DN button—change mode selection

ENTER—Select setting & send data to Column of the Future server

Simulated Primary Display button—Return to main screen

A Navigation Screen part of the Communication Navigation Screen Main Menu of FIG. 15 may also include the following Events/Modes:

Left Menu Scroll—scroll menu button Left

Right Menu Scroll—Scroll menu button right

Show me menu btn—command Nav map to display current GPS location

Find Location Menu Btn—open “Location entry screen”

Zoom Menu Btn—zoom Nav Map In/Out

Compass Rose (8 direction)—Scroll Nav map in selected direction

UP button—scroll menu button UP

DN button—scroll menu button DOWN

Enter Btn—change mode selection

Simulated Primary Display button—Return to Communication Navigation Menu screen

A Route Screen part of the Communication Navigation Screen Main Menu of FIG. 15 may include the following Events/Modes:

Left Menu Scroll—scroll menu button Left

Right Menu Scroll—Scroll menu button right

Abort Route Menu Btn—allow user to abort route

Go To Location Menu btn—Open “location entry screen” go to location

Go to Preset Menu Btn—Route to selected preset

Edit Preset Menu BTN—Edit preset location

UP button—scroll menu button UP

DN button—scroll menu button DOWN

Enter Btn—change mode selection

Simulated Primary Display button—Return to Comm/Nav screen

FIG. 16 depicts an exemplary Entertainment menu as may be displayed on the touch screen interface 80 after the Entertainment category is selected by contact pressure with the stylus 82. Events/Modes depicted in FIG. 16 are shown to include:

Left Menu Scroll—scroll menu button Left

Right Menu Scroll—Scroll menu button right

Source Menu btn—allows user to change Ent. Source

Tune Menu btn—allows user to change tune selection

Preset Menu btn—allows user to change preset selection

Seek Menu btn—allows user to change radio seek mode

Bass Menu btn—allows user to change bass

Treble menu btn—allows user to change treble

Balance Menu btn—allows user to change balance

Fade Menu btn—allows user to change fade

“−” btn—set selected value down

“+” btn—set selected vale up

Enter btn—accepts selected value & send to server

ON/OFF btn—power entertainment system on/off

Play/Pause btn—play/pause CD or DVD

Stop btn—Stop CD or DVD

Mute btn—Mute volume

Volume down btn—set volume down

Volume Up btn—set volume up

Simulated Primary Display button—return to main menu

In the same manner, FIG. 17 displays an exemplary screen interface for Vehicle Information which can be accessed by selecting the Vehicle Information category from the primary menu. Events/Modes depicted in FIG. 17 will be self-evident to those of skill in the art.

And lastly, FIG. 18 shows an exemplary Comfort menu which can be displayed by taping the Comfort mode from the primary menu with the stylus 82. Events/Modes depicted in FIG. 18 are shown to include:

Left Menu Scroll—scroll menu button Left

Right Menu Scroll—Scroll menu button right

Fan Menu btn—allow user to change fan speed

Air Flow menu Btn—allow user to change airflow

AC Menu Btn—allow user to turn AC ON/OFF

Recirc Menu btn—allow user to open—close recirc

Defrost Menu btn—allow user to turn defrost ON/OFF

Temperature Menu btn—allow user to change temperature settings

On btn—turn comfort ON

Off btn—turn OFF comfort

UP btn—change setting up

DOWN btn—change setting down

Enter btn—Accept setting & send to column of the future server

Simulated Primary Display button—Return to main Menu

As will be appreciated, numerous vehicle systems can thus be accessed through any of these menu screens using the same methodology and processes that the owner of the PDA 38′ might use in professional and leisure settings to access calendar information, send emails, look up contact information and the like.

Accordingly, the remote communicator 38′ which operates in the context of a familiar PDA or handheld computer puts the current and remote displays and controls within the hands of the passenger or an occupant. This empowers the holder of the remote communicator 38′ with the ability to change and personalize the main or redundant menus and controls of the vehicle. A basic flow chart process for the remote communicator 38′ may consist of the following steps: first the occupant triggers a vehicle control setting session; second, the occupant selects a vehicle control function through the remote communicator 38′; third, via the remote communicator 38′, the occupant inputs and changes functions and sub-functions; fourth, the remote communicator 38′ transfers the occupant's request to the vehicle architecture, i.e., the computer 22, to execute the commands; fifth, the vehicle architecture responds to the occupant's selection by initiating appropriate action and sending feedback to the remote communicator 38′; and sixth, a solicitation is made for another selection.

A remote communicator 38′ start-up sequence may include the following steps carried out via an internal program contained in the on-board vehicle computer 22: preload the menu screens; internally create and initialize data structures within the remote communicator 38′; remote communicator 38′ attempts to connect to the vehicle server; and remote communicator displays Main Menu Screens as depicted in FIG. 14.

This aspect of the invention as depicted in FIGS. 11-18 focuses on the software program that is used not only for the remote communicator 38′ but is capable of being programmed into any PDA or handheld computer-type unit within range of the internal wireless interface 58. The subject software, which may be factory-loaded on the computer 22, will work on all PDA's connected via either a wireless or direct connect. The software is tailored specifically for the automobile industry, but can be adapted to any industry, including commercial and recreational vehicles to name but two examples. The software can be readily downloaded to any commercially available PDA or handheld computer using existing techniques. This will enable the PDA to perform the same functions as that of the remote communicator 38 described in connection with FIGS. 8-10. The software will allow the PDA or handheld computer to talk via any mode of communication to the on-board vehicle computer 22. Although the preferred method is wireless networking, a hard-wire connection can be used provided the PDA or handheld computer is wired to communicate to the vehicle computer 22 via a harness or cradle configuration. The software in the remote communicator 38′ thus controls the vehicle features and vehicle information systems as previously described. The controlling vehicle features can be limited to specific sub-functions by the vehicle driver, or be fully open and all encompassing as the case may dictate.

A particular advantage of remote communicator 38′ is its use of a PDA, pocket PC and other handheld computer-type device for accessing and processing traditional vehicle controls and display features. The software is the link between the on-board vehicle computer 22 and the handheld device. The software allows the user to simulate the operating instructions by using programmable, user friendly screens as shown in FIGS. 15-18. These screens simulate such displays as the navigation, radio and the HVAC controls. In return, the handheld device 38′, acting through the software, displays a feedback response from the vehicle computer 22 or other such computerized equipment utilizing the simulation display screen.

Accordingly, the subject invention contemplates a method of accessing and controlling electronic functions of the vehicle by combining a vehicle with software that enables any of a number of PDA, pocket PC or handheld computer devices to be programmed. Such handheld devices need not necessarily be dedicated to the vehicle, but can be of the ubiquitous type, i.e., personal to the user and possibly acquired separately from the purchase of the vehicle and which likely has a number of different uses for which PDA's and pocket PCs are typically purchased.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A vehicle information system comprising:
a computer for handling informational data including vehicle data corresponding to operation of a vehicle and associated vehicle systems;
a remote communicator operatively connected to said computer and movable about the vehicle;
said remote communicator including a secondary display for changeably displaying the informational data to an occupant of the vehicle;
said remote communicator also including a secondary input device for sending commands to said computer and controlling said secondary display; and
an internal wireless interface for linking said remote communicator to said computer for communication of the informational data.

2. The system as set forth in claim 1 wherein said secondary display and said secondary input device operate through a shared reconfigurable touch screen interface.

3. The system as set forth in claim 2 wherein said touch screen interface displays a plurality of primary categories, each said primary category comprising a separately selectable mode switch.

4. The system as set forth in claim 3 wherein each of said primary categories can be color-coded with a different color.

5. The system as set forth in claim 3 wherein said primary categories include “Vehicle Information”, “Comfort”, “Entertainment”, and “Communication and Navigation”.

6. The system as set forth in claim 1 wherein said informational data includes external data and said computer includes an external wireless interface to communicate with a network for sending and receiving the external data.

7. The system as set forth in claim 1 wherein said secondary input device includes a telephone.

8. The system as set forth in claim 1 wherein said secondary input device comprises a handheld personal digital assistant.

9. The system as set forth in claim 1 wherein said secondary input device comprises a handheld computer.

10. A method for controlling at least one vehicle system through a handheld wireless device, said method comprising the steps of:
providing a remote communicator having a reconfigurable display screen and an interface responsive to contact pressure;
linking the remote communicator to an on-board vehicular computer through an internal wireless interface;
triggering a vehicle system control setting session via the computer by contact pressure with the remote communicator;
displaying a plurality of vehicle control function choices on the display screen;
selecting a vehicle control function by contact pressure with the remote communicator;
requesting a change in a vehicle control setting by contact pressure with the remote communicator;
receiving the change request in the vehicular computer; and
initiating the change request.

11. The method of claim 10 further including the step of displaying a request for further instructions on the display screen following said step of initiating the change request.
